(19) United States
(12) Patent Application Publication
(10) Pub. No.: US 2017/0143095 A1
(43) Pub. Date: May 25, 2017

(54) AUTOMATIC BLACK HAIR POWDER SPRAY

(71) Applicant: SONGHAK CO., LTD, Gyeongsangnam-do (KR)

(72) Inventors: Junyeong KANG, Seongnam-si (KR); Wanjun KANG, Uiwang-si (KR)

(21) Appl. No.: 15/126,229

(22) PCT Filed: Oct. 2, 2015
(86) PCT No.: PCT/KR2015/010427

§ 371 Date: Feb. 14, 2017

(30) Foreign Application Priority Data
Dec. 19, 2014 (KR) 10-2014-0184943

(51) Int. Cl. A45D 33/02; B05B 7/00; B05B 7/14; A45D 19/02

(52) U.S. Cl. CPC A45D 33/02; A45D 19/02; B05B 7/0081; B05B 7/1413; A45D 2033/001

(57) ABSTRACT

The present invention relates to an automatic black hair powder spray. Particularly, when a cartridge for storing black hair powder is mounted inside a housing in a closed state, the cartridge is pierced such that an external air flows therein and the black hair powder can be discharged together with the inflowing external air and, at this point, a path forming frame, which allows the external air to flow in from the upper part of a cartridge body so as to be guided toward the lower part of the cartridge body, is provided inside the cartridge so as to uniformly disperse all of the black hair powder without the black hair powder accumulating on the inner bottom surface of the cartridge, such that the black hair powder can be discharged in a state in which the black hair powder is uniformly dispersed into the air.

### TECHNICAL FIELD

The present invention relates to an automatic black hair powder spray, particularly, it relates to an automatic black hair powder spray which can conveniently apply black hair powder and also can make possible to apply uniform black hair powder.

### BACKGROUND ART

Hair loss was seen mainly in middle-aged or older generations in the past, but now has increased significantly in young people aged 20-30 due to reasons such as various stress, environmental pollution and consumption of instant food.

Thus, regardless of domestic and foreign, many types of hair loss preventing agent or hair tonic based on oriental and western medicine have been developed, however, so far the proposed products have slight effects or even if it has effects, there are severe problems with physical side effects.

Accordingly, a hair thickener (hair spreading material), so-called black hair powder to cover by dispersing black powder in the visible scalp region of bald hair or thinning hair has been recently developed and used by using the same technique as cosmetics.

This black hair powder in a state where it was stored in a form of powder in a storage container is directly applied to the scalp through a plurality of holes formed on the upper surface, or it is applied by a method such as applying to the scalp by spray injection.

However, the method which applies black hair powder directly to the scalp by shaking the hand holding the storage container on top of head is very difficult to accurately disperse the black hair powder to certain parts of the head, and conventional spray injection method has a problem that the black hair powder is not uniformly applied.

### DETAILED DESCRIPTION OF THE INVENTION

### Technical Problem

The present invention has been devised to solve the problems of the prior art described above, the purpose of which is to provide an automatic black hair powder spray which enables not only to facilitate the application of black hair powder, but to minimize the black hair powder scattered here and there.

Also, the purpose of the present invention is to provide an automatic black hair powder spray which enables that the black hair powder is uniformly contained in air, so that it can be applied uniformly to user's scalp.

### Technical Solution

An automatic black hair powder spray of the present invention for solving the above problems comprises:

a housing equipped with an outlet in an upper end thereof and an intake port formed on a lower part thereof;

a cartridge comprising:
a cartridge body which is removably installed inside of the housing and stores black hair powder, wherein an air inlet is formed on an upper part thereof;
a path forming frame which is removably coupled to an internal surface having an air inlet in the cartridge body, in a box shape with opened front and bottom sides thereof, and wherein according to coupling with the internal surface of the cartridge body, a path tunnel is made therein which guides an inflowing air through the air inlet to a bottom part of the cartridge body; and
a cover which is installed in an opened upper surface of the cartridge body and a discharge port is formed therein to discharge air containing black hair powder; and

a blast fan unit which is installed inside of the housing and inhales an external air through the intake port and then provides air to an inside of the cartridge through the air inlet so as to provide blast force to discharge the black hair powder stored inside of the cartridge through the discharge port and the outlet.

And the housing further comprises a piercing path which guides an inflowing external air from the intake port into the cartridge, wherein the piercing path and the outlet protrude by a predetermined length with a pointed shape at their end in the direction in which the cartridge is mounted, and when the cartridge is installed in the housing, the air inlet and the discharge port that are closed are pierced by the piercing path and the outlet, to be then opened.

At this time, a pair of left and right flexible connecting pieces which are horizontally extended and vertically bent at both left and right ends of an opened front side in the path forming frame are provided and extended along longitudinal direction of the path forming frame, and a protruded side plate is formed to be extended upward and downward in a form of a rectangle in the internal surface of the cartridge body coupled with the path forming frame so as to fix the path forming frame to an external surface of the side plate via the flexible connecting piece by force-fitting.

Also, the path forming frame has a shape that a flat cross section area becomes smaller as it goes down, and a lower inclined surface which becomes more protruding to front side as it goes down is formed in a lower end part of the side plate.

### Advantageous effect

An automatic black hair powder spray of the present invention constituted as described above has advantages that it is convenient to apply black hair powder since it sprays required part of head with black hair powder stored inside of a cartridge only by manipulating to press an operation button on a housing, as well as it is able to prevent wasting of black hair powder scattered here and there since it does not require to shake hands to apply black hair powder on head.

Also it has advantages that since a path tunnel of a cartridge is formed in which a cross section area becomes smaller as it goes down, the flow rate of air increases and black hair powder can be uniformly dispersed into the air so that it allows the black hair powder to be uniformly applied on head.

### BRIEF DESCRIPTION OF THE DRAWINGS

FIG. 1 is a whole combined perspective view of an automatic black hair powder spray according to the present invention.

FIG. 2 is a whole exploded perspective view of an automatic black hair powder spray according to the present invention.

FIG. 3 is a whole internal sectional view of an automatic black hair powder spray according to the present invention.

FIG. 4 is an exploded perspective view of an automatic black hair powder spray with a cartridge being exploded, according to the present invention.

FIGS. 5 to 6 are a combined perspective view of an automatic black hair powder spray with a cartridge assembled therein, and a view that air flows therein are shown, according to the present invention, respectively.

FIG. 7 is a sectional view of an automatic black hair powder spray according to the present invention, which is showing air flows therein and flow of black hair powder together with air being discharged therefrom.

DESCRIPTION OF SYMBOLS

| | |
|---|---|
| 100: a housing | 110: a front cover |
| 111: an operation button | 120: a body |
| 121: an outlet | 122: an intake port |
| 123: a piercing path | 130: an opening and closing cover |
| 140: a bottom plate | |
| 200: a cartridge | 210: a cartridge body |
| 211: an air inlet | 220: a path forming frame |
| 221: a path tunnel | 222: a backflow prevention plate |
| 222a: a piercing hole | 223a: a central outlet hole |
| 224: an inserting wing | 225: a flexible connecting piece |
| 230: a cover | 231: a discharge port |
| 232: a side plate | 233: a wing inserting-fixation member |
| 300: a blast fan unit | 310: a motor |
| 320: a blast fan | 400: a battery |

### DETAILED DESCRIPTION

Hereinafter, embodiments of an automatic black hair powder spray of the present invention will be described in detail with reference to the accompanying drawings.

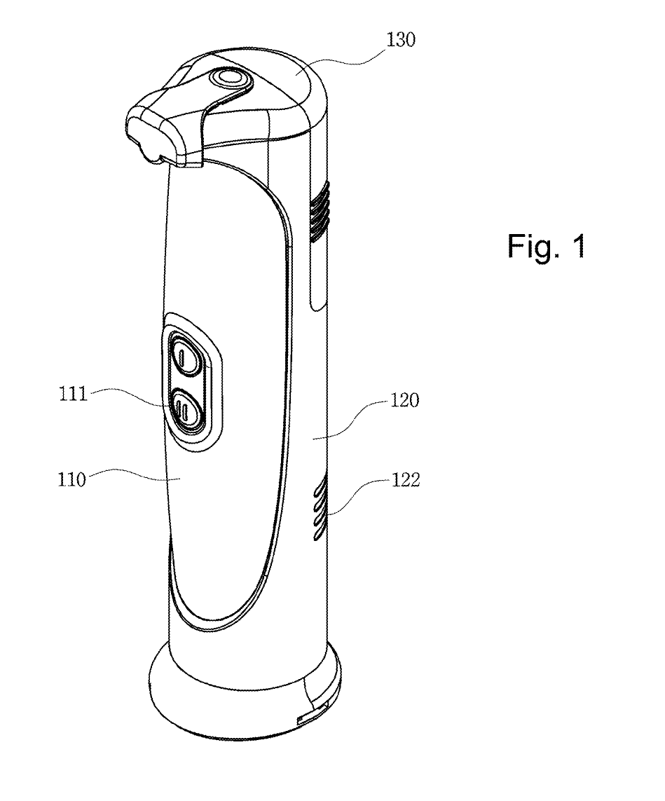

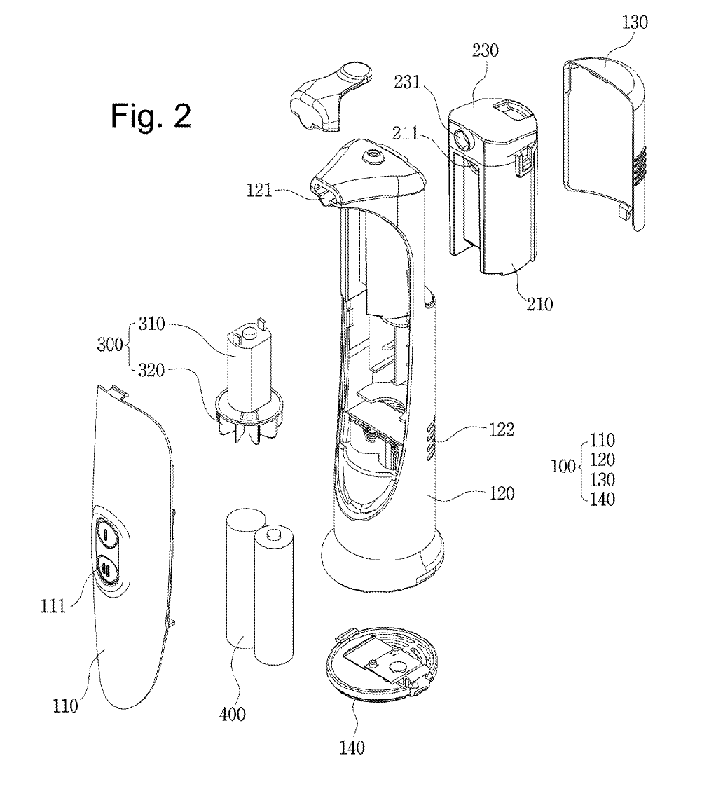

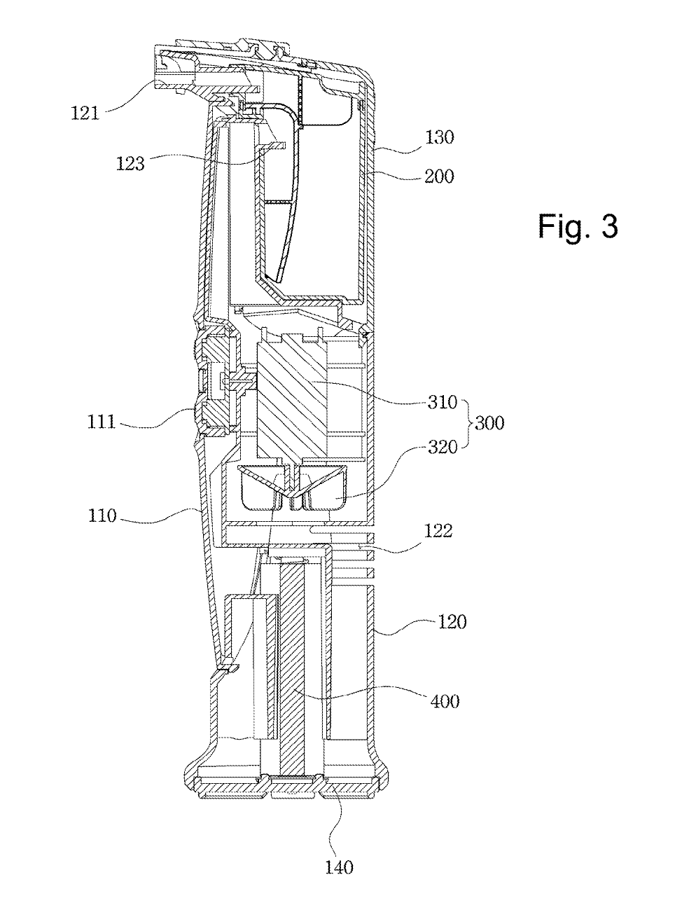

FIGS. 1 to 3 are is a whole combined perspective view, a whole exploded perspective view and internal sectional view of an automatic black hair powder spray according to the present invention.

With reference to FIGS. 1 to 3, an automatic black hair powder spray of the present invention consists of a housing (100) equipped with an outlet (121) in an upper end thereof and an intake port (122) formed on a lower part thereof; a cartridge (200) installed in an upper part of an inside of the housing (100); a blast fan unit (300) installed in a middle part of an inside of the housing (100); and a battery (400) installed in a lower part of an inside of the housing (100).

The housing (100), as a part constituting an outer appearance of an automatic black hair powder spray, embeds therein a cartridge (200), a blast fan unit (300) and a battery (400) as described above. The housing (100) consists of a front cover (110), a body (120) wherein the front cover (110) is formed in front thereof, and an opening and closing cover (130) which is formed in rear of the body (120).

The front cover (110) is equipped with a number of operation button (111) formed in center part thereof.

The operation button (111) supplies or blocks power from the battery (400) to the blast fan unit (300). Accordingly, the blast fan unit (300) is operated by pressing any one operation button (111) of a number of these operation buttons (111) and operation of the blast fan unit (300) is stopped by pressing other operation button (111).

The body (120), as a part which roles as a frame of the housing (100), provides spaces in upper, middle, and lower parts of the inside in which the cartridge (200), the blast fan unit (300), and the battery (400) can be installed, respectively. In this body (120), an outlet (121) is equipped in an upper end thereof, also an intake port (122) is formed on a lower part thereof and a piercing path (123) is formed immediately below the outlet (121).

The outlet (121) is formed in an upper end of the body (120) toward a front and black hair powder to be sprayed by air is discharged out through the outlet (121) and then applied to user's scalp.

At this time, the outlet (121) protrudes by a predetermined length with a pointed shape at its end toward inside of the body (120) in order to pierce a discharge port (231) of a cartridge (200) as hereafter described when the cartridge (200) is installed in the body (120). Like this, the outlet (121) of the cartridge (200) is pierced wherein the outlet (121) is closed, so that an internal space of the cartridge (200) communicates with a discharge port (231) each other.

The intake port (122) is a part which inhales an external air and when the blast fan unit (300) operates, an external air is flowing into the intake port (122) by suction force of the blast fan unit (300).

The piercing path (123) is formed below the outlet (121) inside of the body (120) and like the outlet (121), it protrudes by a predetermined length with a pointed shape at its end toward inside of the body (120) in order to pierce an air inlet (211) of a cartridge (200) as hereafter described when the cartridge (200) is installed in the body (120). Like this, the piercing path (123) pierces the air inlet (211) of the cartridge (200) that is closed, so that an internal space of the cartridge (200) communicates with the intake port (122) each other via the piercing path (123).

The opening and closing cover (130) is installed in a rear upper part of the body (120) and prevents a cartridge (200) installed in the body (120) from being exposed outside.

Hereinafter, a cartridge (200) of the present invention will be described in more detail.

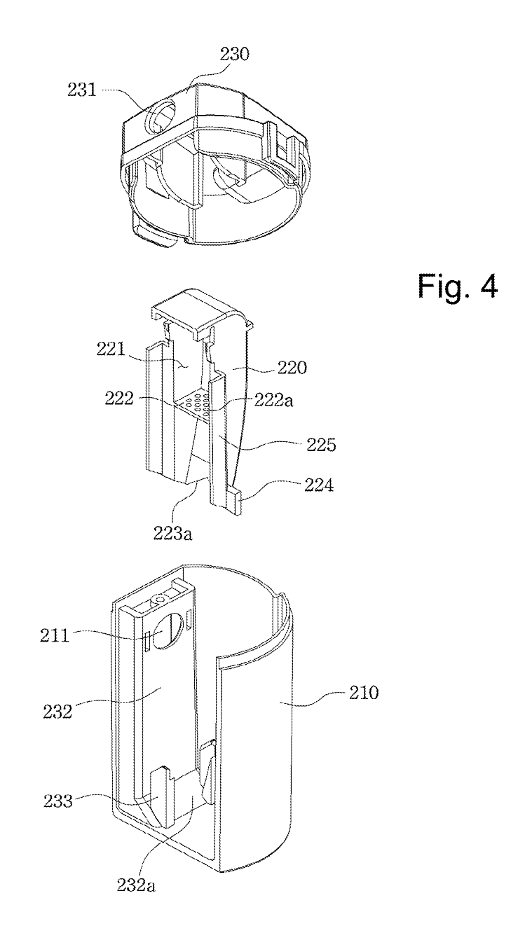

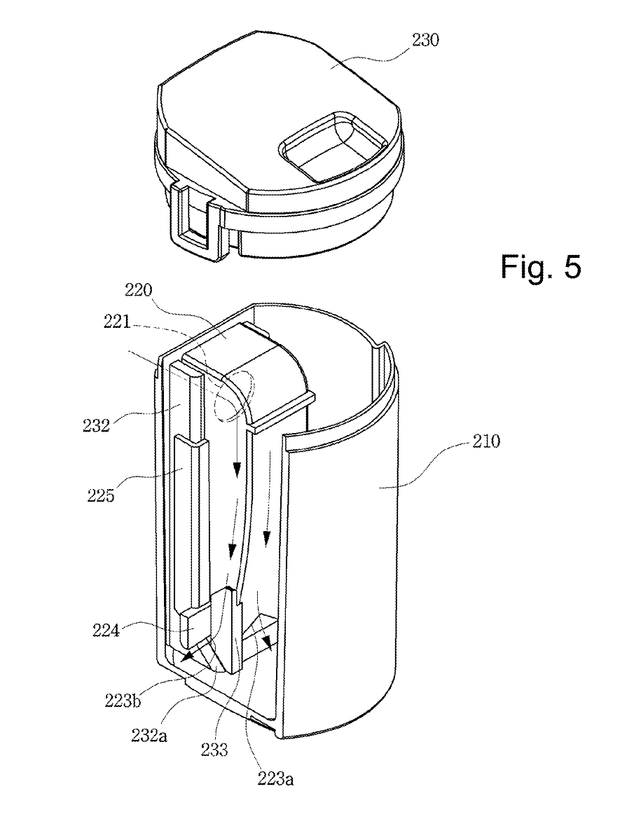

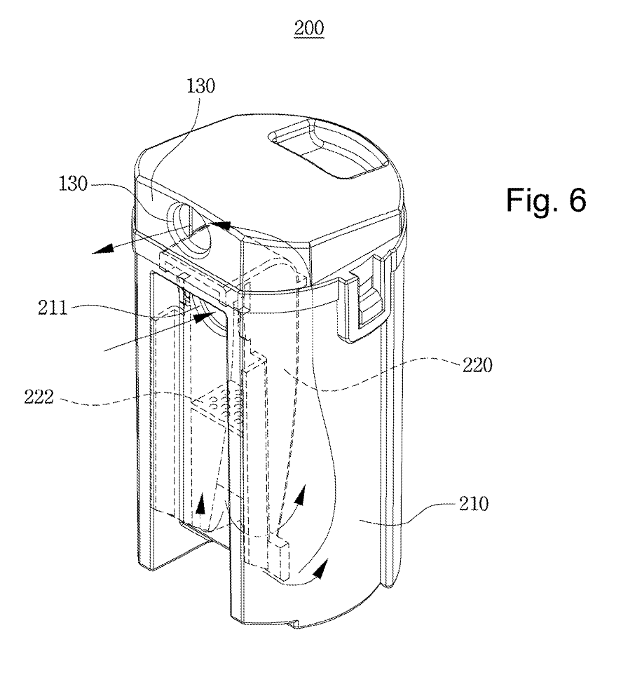

In this connection, FIG. 4 is an exploded perspective view of a cartridge of an automatic black hair powder spray according to the present invention, and FIGS. 5 to 6 are a combined perspective view of a cartridge of an automatic black hair powder spray according to the present invention, and a view that shows air flows, respectively.

The cartridge (200) stores black hair powder in an internal space thereof and it is removably installed by sliding in a rear upper part of the inside of the housing (100). The cartridge (200) consists of a cartridge body (210) in which an upper surface is opened, a path forming frame (220) installed inside of the cartridge body (210), and a cover (230) installed in an opened upper surface of the cartridge body (210).

The cartridge body (210) is installed inside of the housing (100), that is, inside of a rear upper part of the body (120), and it forms a storage space inside thereof and stores black hair powder in the storage space. In the internal surface of the cartridge body (210), a protruded side plate (232) in a form of a rectangle is formed to be extended along longitudinal direction of the cartridge body (210). In an upper part of the side plate (232), an air inlet (211) which allows an external air to flow therein is formed. Here, the air inlet (211) initially takes a closed form to prevent leakage of a black hair powder stored inside the cartridge (200). In this state, when the cartridge (200) is installed in the housing (100), the air inlet (211) which is closed is pierced by the piercing path (123), to be then opened.

The path forming frame (220) is formed as a box shape with respective opened front and bottom sides and is provided to be extended along vertical direction inside of the cartridge body (210). Inside of the cartridge body (210), the path forming frame (220) provides a space compartmentalized from a space which stores black hair powder, and it guides and discharges an inflowing external air, which is flowing into inside the cartridge body (210) from an upper part thereof, to a bottom part thereof.

Specifically, an opened front side of a path forming frame (220) is coupled with a side plate (232) in a direction heading for the side plate (232) which protrudes toward the inside of the cartridge body (210). In the path forming frame (220), according to coupling with the side plate (232) of the cartridge body (210), a sealed internal space, that is, a path tunnel (221) which an inflowing external air which is flowing from the air inlet (211) can pass through, is made between the path forming frame (220) and the side plate (232) of the cartridge body (210).

Accordingly, the inflowing external air which is flowing from the air inlet (211) is discharged through the path tunnel (221) which is formed between the path forming frame (220) and the side plate (232) into an opened lower part of the path forming frame (220). Additionally, the path tunnel (221) is extended in upward and downward direction and an upper part of the path tunnel (221) communicates with the air inlet (211), so that the inflowing external air, which is flowing into the inside of the path tunnel (221) through the air inlet (211), flows to a lower part thereof.

The path forming frame (220) has a shape that a flat cross section area becomes smaller as it goes down from top. Accordingly, the path tunnel (211) forming the internal space of the path forming frame (220) has a flat cross section area which becomes smaller as it goes down from top, so that a flow rate of air flowing through the path tunnel (211) is becoming increasingly faster from up to down. Like this, the flow rate of air is becoming faster as it goes down (to outlet), so that black hair powder is contained in a discharged air while being evenly dispersed.

At this time, a lower inclined surface (232a) which becomes more protruding to front side at an angle as it goes down from top is formed in a lower part of a side plate (210) (in an air outlet of the path forming frame (220)). Accordingly, a cross section area of the air outlet of the path forming frame (220) is made very small so that an air to be discharged is sprayed very quickly and strongly.

Also, a flexible connecting piece (225) being flexibly coupled with the side plate (232) of the cartridge body (210) is provided in an opened front side in the path forming frame (220). A pair of left and right flexible connecting pieces (225) are horizontally extended toward the outside and then vertically bent toward the front side at both sides of an opened front side in the path forming frame (220), that is, ‘’ shape when viewed from above is formed, and wherein the pair of left and right flexible connecting pieces (225) are provided and extended along longitudinal direction of the path forming frame (220) to face against each other.

The side plate (232) protruding internally on the cartridge body (210) is coupled wherein it is fitted between the pair of left and right flexible connecting pieces (225) provided in a front side of the path forming frame (220). In this case, an interval between left and right flexible connecting pieces (225) is made slightly smaller than a width of the side plate (232). Accordingly, while the path forming frame (220) is being coupled with the side plate (232), elastic deformation occurs wherein a flexible connecting piece (225) is bent to outside, and then upon completion of coupling, by the elastic force from the flexible connecting piece (225) restoring to its original position, it can be strongly fixedly coupled with the side plate (232) while maintaining tightness.

With reference to a coupling structure of the path forming frame (220) and the side plate (232), in the present invention, each means of inserting-fixation is provided therein to ensure fixation between the path forming frame (220) and the side plate (232). For this, a wing inserting-fixation member (233) forming inserting-space is provided in a lower part of the side plate (232) and an inserting wing (224) to be inserted into the wing inserting-fixation member (233) is provided in the path forming frame (220).

The inserting wing (224) is inserting-fixed between the wing inserting-fixation member (233) and the side plate (232) and it is provided in form of wing and outwardly extended to protrude on both left and right sides in lower end of the path forming frame (220). At this time, the inserting wing (224) is formed in rear of the flexible connecting piece (225).

The wing inserting-fixation member (233) vertically upwardly protrudes on both left and right lower end parts of the lower inclined surface (232a) of the side plate (232), and a pair of these are arranged to face each other in left and right. That is, the wing inserting-fixation member (233) is arranged in parallel with the side plate (232) in front and rear while a space (interval) is formed wherein the inserting wing (224) is inserted therebetween.

Like this, the path forming frame (220) is inserted between the wing inserting-fixation member (233) and the side plate (232) via the inserting wing (224) so that it can be more firmly coupled.

At this time, the wing inserting-fixation member (233) is formed in an end of the lower inclined surface (232a) protruded forwardly so that an interval between the wing inserting-fixation member (233) and the side plate (232) becomes smaller as it goes down from top. Therefore the inserting wing (224) of the path forming frame (220) is not inserted throughout into a bottom end of the between the wing inserting-fixation member (233) and the side plate (232). That is, the inserting wing (224) of the path forming frame (220) is inserted between the wing inserting-fixation member (233) and the side plate (232) to some degree of height. Accordingly, in a state in which the inserting wing (224) of the path forming frame (220) is fully inserted between the wing inserting-fixation member (233) and the side plate (232), a gap is formed therebelow. Through the gap, an air flowing inside the path forming frame (220) is discharged outside. Hereinafter, this gap is referred as a side direction outlet hole (232b).

Like this, the path forming frame (220) is coupled with the side plate (232) of the cartridge body (210) so that the path tunnel (221) that is space in which air flows is formed therein and air is discharged through an opened bottom side (low surface) and a side direction outlet hole (232b) therebelow. At this time, an opened side, that is, a central outlet hole (232a), which is cut in a form of a triangle having decreasing width as it goes upward is provided in an end part of a front side forming an opened bottom side of the path forming frame (220).

Accordingly, a discharged air downward the path forming frame (220) is guided along the lower inclined surface (232a) of the side plate (232) and it is discharged downward and forward through a central outlet hole (232a) as well as it is discharged in a side direction through the side direction outlet hole (232b) formed in a side. At this time, since the side direction outlet hole (232b) is formed below the inserting wing, a discharged air from the side direction outlet hole (232b) is not passing through directly upward but passing through in a side direction in a predetermined section along a base surface of the inserting wing (224) after it was discharged, so that it shakes all black hair powder accumulated in the base corner of a cartridge body and it is able to externally discharge.

The cover (230) is a part wherein a discharge port (231) is formed and an air containing black hair powder is guided to the discharge port (231) and then discharged.

The discharge port (231) is formed in the cover (230) and initially it is closed to prevent leakage of a black hair powder stored inside cartridge (200). In this state, when the cartridge (200) is installed in the body (120), the discharge port (231) that is closed is pierced by an internal end of the outlet (121). With this, the outlet (121) and the discharge port (231) communicate with each other.

Accordingly, an external air discharged to below and both sides of the path tunnel (221) via the path forming frame (220) shakes black hair powder stored inside cartridge body (210) and then it ascends upward with black hair powder. An ascending air with black hair powder is discharged outside from the outlet (121) of the housing (100) via the discharge port (231) of the cover (230).

The blast fan unit (300) is installed in a middle inside the housing (100) and inhales an external air through the intake port (122) and then provides air to an inside of the cartridge (200) through the air inlet (211) so as to discharge the black hair powder stored inside of the cartridge (200) through the discharge port (231) and the outlet (121).

This blast fan unit (300) consists of a motor (310) and a blast fan (320) which is installed in a motor shaft of the motor (310).

The motor (310) operates using power supplied from the battery (400).

When power is supplied to the motor (310), the blast fan (320) rotates together with a motor shaft so that it inhales an external air from the intake port (122). The external air inhaled by the blast fan (320) is provided inside the cartridge body (210) of the cartridge (200) through the air inlet (211).

The battery (400), which supplies the blast fan unit (300) with power, is installed in a lower part of the inside the housing (100). In more detail, in the housing (100), a bottom plate (140) is removably installed at a base of the body (120), and wherein the battery (400) is inserted inside the body (120) after separating the bottom plate (140) from the body (120). And then, the bottom plate (140) is coupled with the body (120) to prevent exposure of the battery (400).

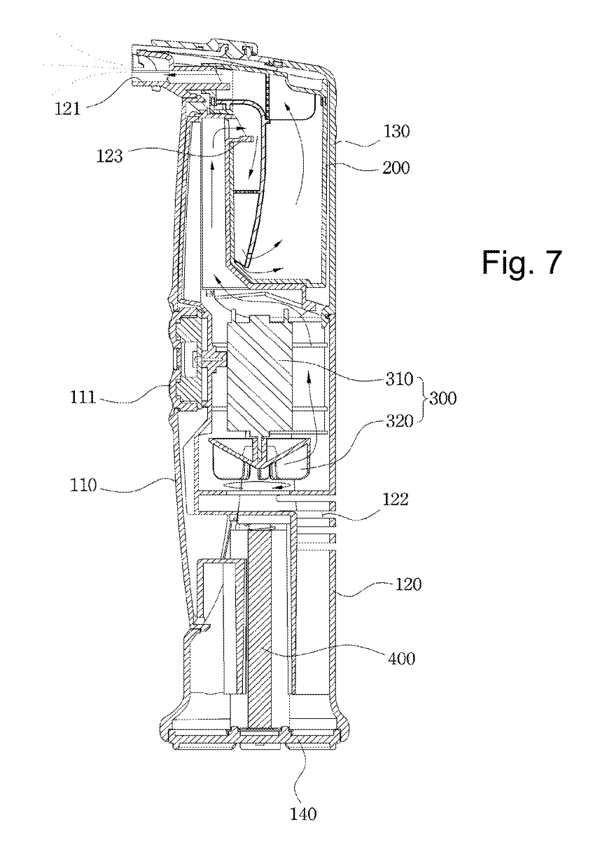

The brief description of an operation of an automatic black hair powder spray according to the present invention configured as described above is as follows. In this connection, FIG. 7 is a sectional view of an automatic black hair powder spray according to the present invention, which is showing air flow therein and flow of black hair powder with air discharged therefrom.

First, when the cartridge (200) is installed in the housing (100), the discharge port (231) and the air inlet (211) that are closed are pierced by the outlet (121) and the piercing path (123) that are protruded by a predetermined length with a pointed shape at their end in a direction from the body (120) toward inside thereof, to be then opened, so that the discharge port (231) and the air inlet (211) of the cartridge (200) communicate with the intake port (122), the piercing path (123) and the outlet (121) that are provided in the housing (10) to enable air to flow.

And when the blast fan unit (300) is supplied power by pressing the operation button (111) of the front cover (110), the motor (310) operates so that the blast fan (320) rotates.

The suction force is generated by rotation of the blast fan (320), and the external air is inhaled into the inside of the housing (100) through the intake port (122) of the body (120).

An inflowing air into the inside of the housing (100) flows into inside the cartridge (200) through the piercing path (123) of the body (120) and the air inlet (211) of the cartridge (200).

An inflowing air into the inside of the cartridge (200) flows down along the path tunnel (221) of the path forming frame (220), and then passes through a piercing hole (222a) of a backflow prevention plate (222).

An air passing through the piercing hole (222a) of the backflow prevention plate (222) is diffused to downward and in both left and right sides along a central outlet hole (223a) and a side direction outlet hole (223b) that are provided in a lower part and left and right sides of the path forming frame (220), and thereafter it disturbs the black hair powder. Then, it contains black hair powder and ascends upward and passes through the piercing hole (232a), continuously it is discharged outside through the discharge port (231) and the outlet (121).

Meanwhile, however, an automatic black hair powder spray according to the present invention is described as it stores black hair powder inside the cartridge (200) and then sprays them therefrom, it is also possible that other kinds of powder which are not the black hair powder are stored inside the cartridge (200) and then sprayed. That is, what can be stored in the cartridge (200) is not limited to the black hair powder, and other kinds of powder are also possible.

1. An automatic black hair powder spray comprising:
a housing (100) equipped with an outlet (121) in an upper end thereof and an intake port (122) formed on a lower part thereof;
a cartridge (200) comprising:
a cartridge body (210) which is removably installed inside of the housing (100) and stores black hair powder, wherein an air inlet (211) is formed on an upper part thereof;
a path forming frame (220) which is removably coupled to an internal surface having an air inlet (211) in the cartridge body (210), in a box shape with opened front and bottom sides thereof, and wherein according to coupling with the internal surface of the cartridge body (210), a path tunnel (221) is made therein which guides an inflowing air through the air inlet (211) to a bottom part of the cartridge body (210); and
a cover (230) which is installed in an opened upper surface of the cartridge body (210) and a discharge port (231) is formed therein to discharge air containing black hair powder; and a blast fan unit (300) which is installed inside of the housing (100) and inhales an external air through the intake port (122) and then provides air to an inside of the cartridge (200) through the air inlet (211) so as to provide blast force to discharge the black hair powder stored inside of the cartridge (200) through the discharge port (231) and the outlet (121).

2. An automatic black hair powder spray according to claim 1, the housing (100) further comprising a piercing path (123) which guides an inflowing external air from the intake port (122) into the cartridge (200), wherein the piercing path (123) and the outlet (121) protrude by a predetermined length with a pointed shape at their end in the direction in which the cartridge (200) is mounted, and when the cartridge (200) is installed in the housing (100), the air inlet (211) and the discharge port (231) that are closed are pierced by the piercing path (123) and the outlet (121), to be then opened.

3. An automatic black hair powder spray according to claim 1, wherein a pair of left and right flexible connecting pieces (225) which are horizontally extended and vertically bent at both left and right ends of an opened front side in the path forming frame (220) are provided and extended along longitudinal direction of the path forming frame (220), and wherein a protruded side plate (232) is formed to be extended upward and downward in a form of a rectangle in the internal surface of the cartridge body (210) coupled with the path forming frame (220) so as to fix the path forming frame (220) to an external surface of the side plate (232) via the flexible connecting piece (225) by force-fitting.

4. An automatic black hair powder spray according to claim 1, wherein the path forming frame (220) has a shape that a flat cross section area becomes smaller as it goes down, and a lower inclined surface (232a) which becomes more protruding to front side as it goes down is formed in a lower end part of the side plate (232).

5. An automatic black hair powder spray according to claim 4, wherein a pair of left and right wing inserting-fixation members (233) are provided, which vertically upwardly protrude on both lower parts of left and right of the lower inclined surface (232a) of the side plate (232) so as to face against and form a predetermined interval with the side plate (232), and an inserting wing (224) to be horizontally extended by predetermined length in a form of a wing, on both left and right sides in bottom side of the path forming frame (220) is fixed between the side plate and the wing inserting-fixation member.

6. An automatic black hair powder spray according to claim 5, when an inserting-fixation is completed between the side plate (232) and the wing inserting-fixation member (233), a side direction outlet hole (223b) is formed therebetween in the path forming frame (220), which is a gap which is not completely inserted therebetween in a lower part, and a central outlet hole (223a) is provided in a form of a triangle having decreasing width as it goes upward in a lower front side of the path forming frame (220).

7. An automatic black hair powder spray according to claim 5, wherein the path forming frame (220) is provided with a backflow prevention plate (222) in which a number of piercing hole (222a) are formed in a path tunnel (221).

8. An automatic black hair powder spray according to claim 3, wherein the path forming frame has a shape that a flat cross section area becomes smaller as it goes down, and a lower inclined surface which becomes more protruding to front side as it goes down is formed in a lower end part of the side plate.
